(19) United States
(12) Patent Application Publication
(10) Pub. No.: US 2013/0274017 A1
(43) Pub. Date: Oct. 17, 2013

(54) TRACKBALL CONTROL DEVICE FOR GAME CONSOLE

(71) Applicant: Wei-Liang Liao, New Taipei City (TW)

(72) Inventor: Wei-Liang Liao, New Taipei City (TW)

(73) Assignee: SAINT-FUN INTERNATIONAL LTD., New Taipei City (TW)

(21) Appl. No.: 13/447,257

(22) Filed: Apr. 15, 2012

(51) Int. Cl. A63F 13/06

(52) U.S. Cl. 463/37

(57) ABSTRACT

A trackball control device for a game console includes a base, a trackball and a face panel. The base includes three bearing rollers thereon. Two of the bearing rollers are perpendicular to one another and respectively provided with a decoder. The other bearing roller not having the decoder is located between the two bearing rollers having the decoder. The base includes pillars at four corners thereof. The trackball is disposed between the three bearing rollers. The face panel is locked to the pillars. A portion of the trackball is exposed out of an opening of the face panel. The three bearing rollers are to receive and position the trackball. The trackball is operated smoothly to lower resistance when the trackball is operated. When the trackball is operated, the two sensors detect the displacement of the X-axis and Y-axis for operation of the screen of the game console.

### BACKGROUND OF THE INVENTION

(a) Field of the Invention

The present invention relates to a trackball control device for a game console, and more particularly, to one having three bearing rollers and two decoders to lower the resistance of a trackball so that the trackball can be operated smoothly and exactly.

(b) Description of the Prior Art

A conventional trackball comprises a base, a detection module and an electronic base plate to bear the base and the detection module. The base comprises a plurality of bear frames which are provided with rolling balls to bear a ball. An optical detect module and the electronic base plate are used to provide operation of displacement.

When the trackball is operated, the bearing structure the trackball has greater resistance. When in use, the trackball cannot be operated smoothly. In particular, the operation of the screen of the game console cannot follow the change of the complicated game to be operated exactly. How to improve smoothness of the trackball operation of the game console is an import issue. Accordingly, the inventor of the present invention has devoted himself based on his many years of practical experiences to solve these problems.

### SUMMARY OF THE INVENTION

The primary object of the present invention is to provide a trackball control device for a game console. The trackball control device comprises a base, a trackball and a face panel. The base comprises three bearing rollers thereon. Two of the bearing rollers are perpendicular to one another, and are respectively provided with a decoder. The other bearing roller not having the decoder is located between the two bearing rollers having the decoder. The base comprises four pillars at four corners thereof. The trackball is disposed between the three bearing rollers. The face panel is locked to the pillars of the base. A portion of the trackball is exposed out of an opening of the face panel. The three bearing rollers are adapted to receive and position the trackball. The trackball is operated smoothly to lower resistance when the trackball is operated. When in use, the trackball can be operated quickly, flexibly and exactly to enhance the whole operation of the game console.

Preferably, the three bearing rollers of the base are respectively connected with a fixture. The two decoders are an X-axis decoder and a Y-axis decoder. Each of the decoders comprises a code disk and a sensor. The code disk and the relative bearing roller are coaxial. The code disk mates with the sensor for the code disk to be synchronously turned along with the relative bearing roller. The sensor detects the displacement of the X-axis and Y-axis to transmit the information of detection for operation of the screen of the game console.

Preferably, each of the three bearing rollers has a contact point to get in touch with the trackball. The contact points of the three bearing rollers are disposed at the same height. The height of the contact point is a half of the radius of the trackball.

### BRIEF DESCRIPTION OF THE DRAWINGS

FIG. 1 is a perspective view according to a preferred embodiment of the present invention;

FIG. 2 is an exploded view according to the preferred embodiment of the present invention;

FIG. 3 is an exploded view of the base according to the preferred embodiment of the present invention;

FIG. 4 is a top view of the base according to the preferred embodiment of the present invention;

FIG. 5 is a top view according to the preferred embodiment of the present invention;

FIG. 6 is a sectional view taken along line A-A of FIG. 5; and

FIG. 7 is a schematic view showing operation of the trackball of the present invention.

### DETAILED DESCRIPTION OF THE PREFERRED EMBODIMENTS

Embodiments of the present invention will now be described, by way of example only, with reference to the accompanying drawings.

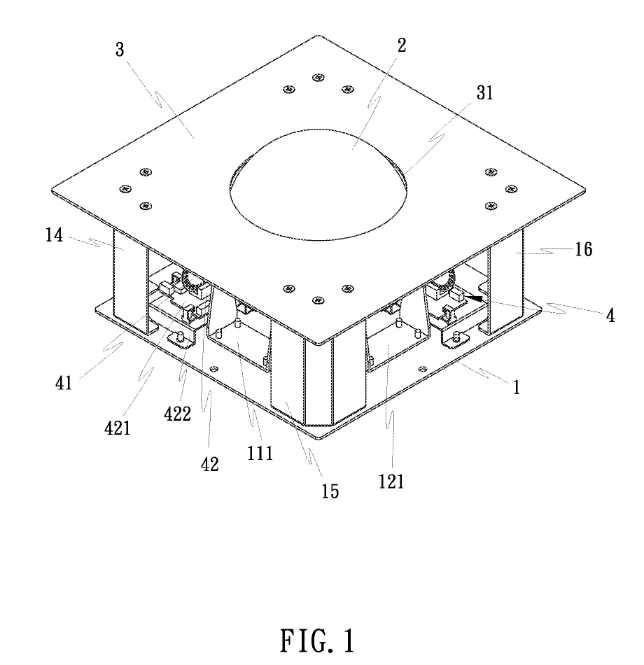

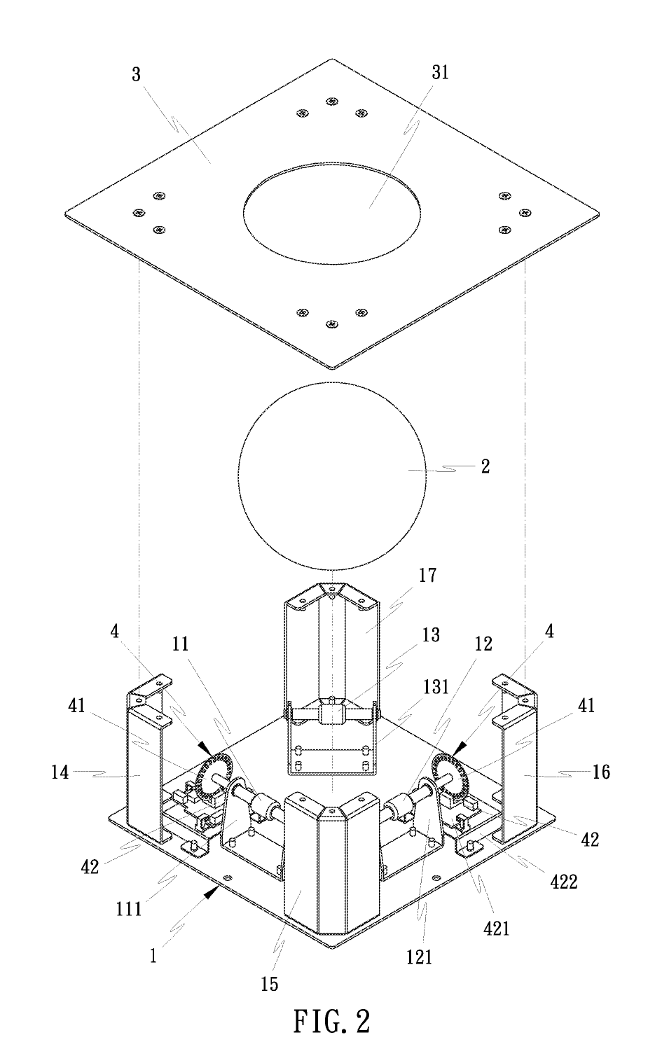

As shown in FIG. 1 and FIG. 2, a trackball control device for a game console according to a preferred embodiment of the present invention comprises a base 1, a trackball 2 and a face panel 3.

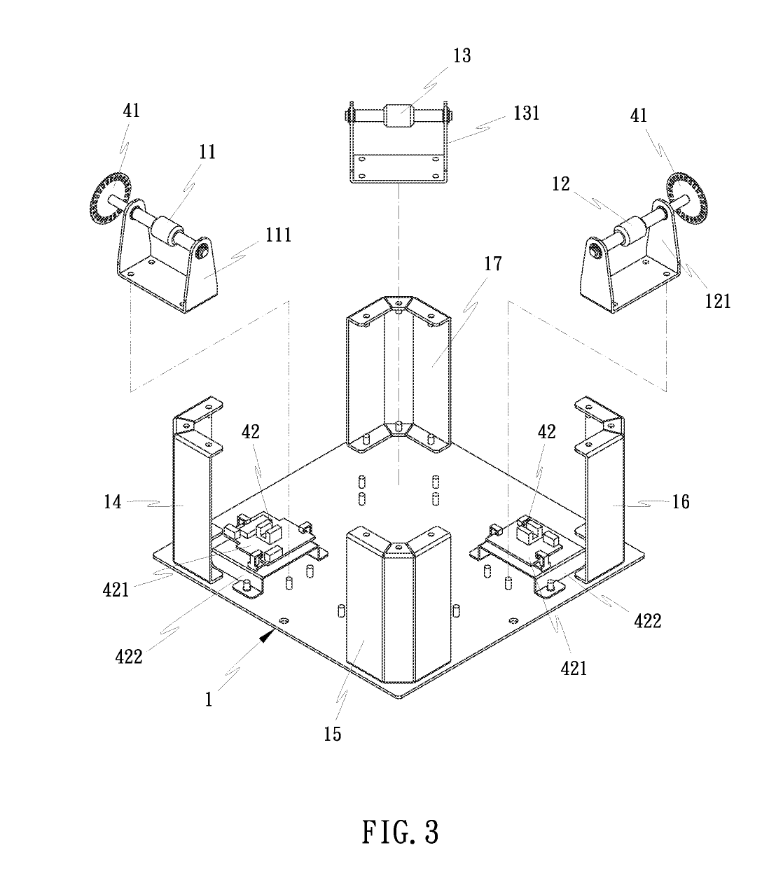

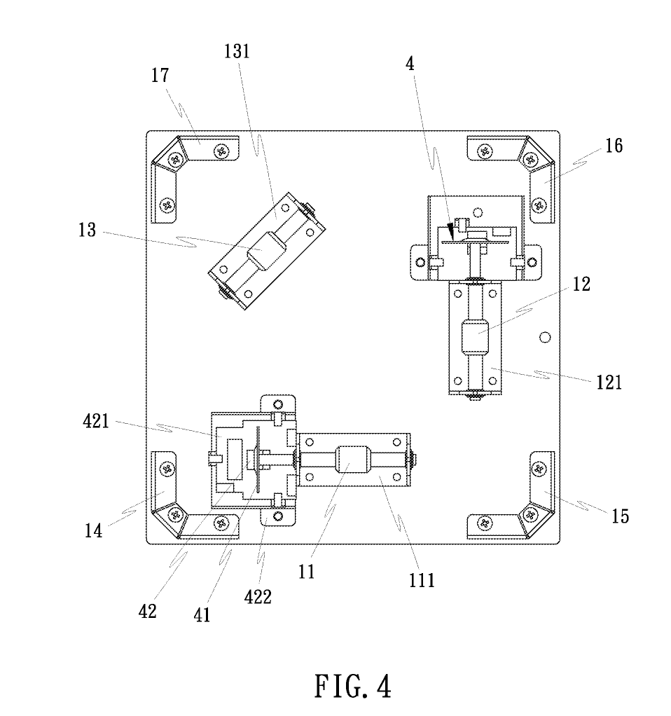

As shown in FIG. 3, the base 1 comprises three bearing rollers 11, 12, 13 thereon. Two of the bearing rollers 11, 12 are perpendicular to one another, as shown in FIG. 4, and are respectively provided with a decoder 4. The other bearing roller 13 not having the decoder 4 is located between the two bearing rollers 11, 12. The base 1 comprises four pillars 14, 15, 16, 17 at four corners thereof.

The trackball 2 is a globe.

The face panel 3 has an opening 31.

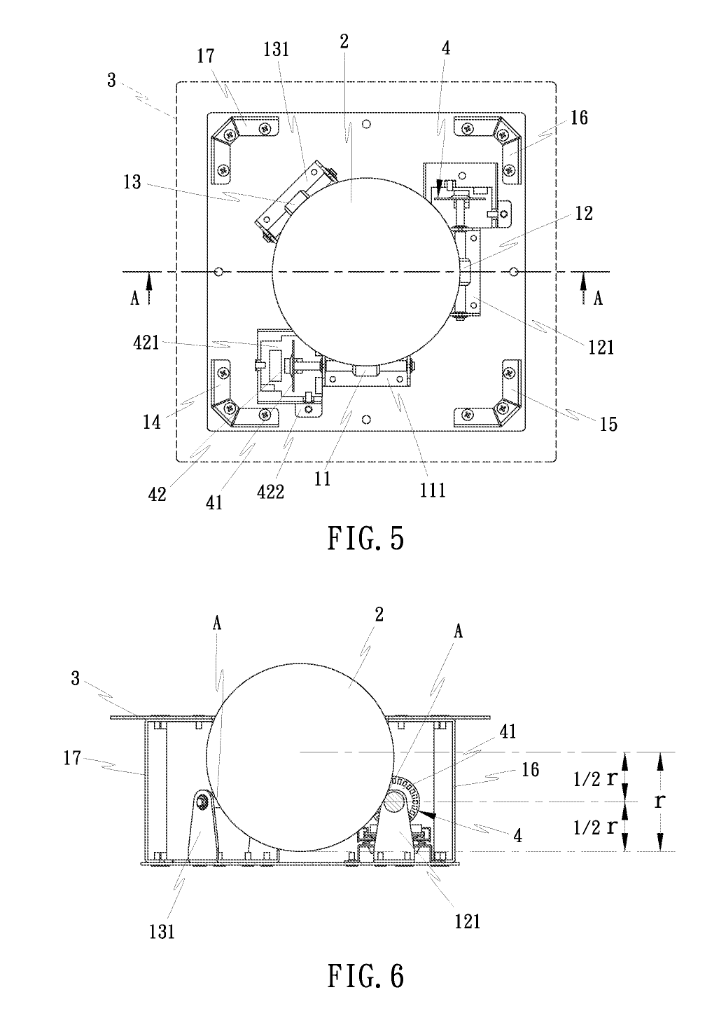

The trackball 2 is disposed between the three bearing rollers 11, 12, 13. The face panel 3 is locked to the pillars 14, 15, 16, 17 of the base 1. A portion of the trackball 2 is exposed out of the opening 31 of the face panel 3. The three bearing rollers 11, 12, 13 are adapted to receive and position the trackball 2, as shown in FIG. 5. In this way, the trackball 2 can be operated smoothly to lower the resistance when the trackball 2 is operated. When in use, the trackball 2 can be operated quickly, flexibly and exactly to enhance the whole operation of the game console.

The three bearing rollers 11, 12, 13 of the base 1 are respectively connected with a fixture 111, 121, 131. Each of the three bearing rollers 11, 12, 13 has a contact point to get in touch with the trackball 2. The contact points of the three bearing rollers 11, 12, 13 are disposed at the same height.

As shown in FIG. 6, the contact points of the three bearing rollers 11, 12, 13 to get in touch with the trackball 2 are at the same height. The height of the best contact point A is a half of the radius of the trackball 2.

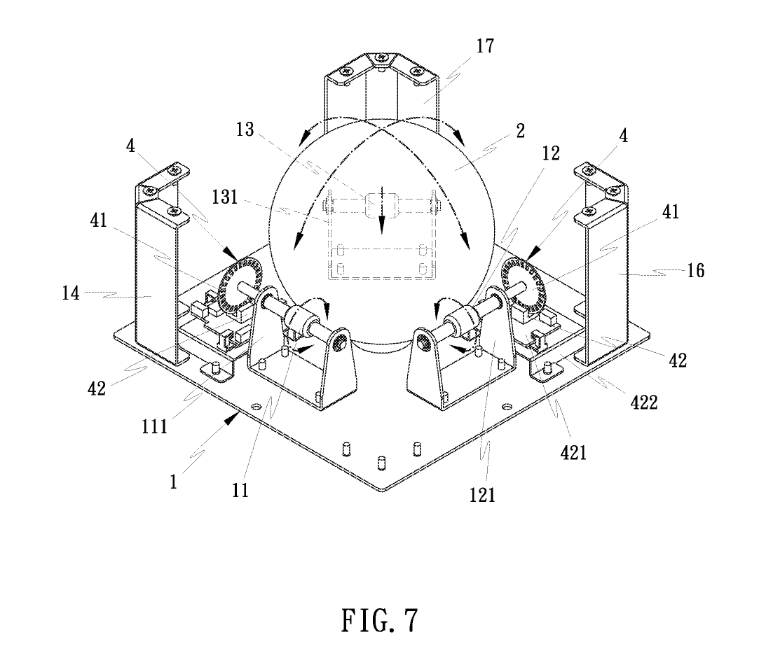

The present invention is provided with two decoders 4, one is an X-axis decoder 4 and the other is a Y-axis decoder 4. Each of the decoders 4 comprises a code disk 41 and a sensor 42. The code disk 41 and the relative bearing roller 11 or 12 are coaxial. The code disk 41 is mating with the sensor 42 for the code disk 41 to be synchronously turned along with the bearing roller 11, 12. The sensor 42 detects the displacement of the X-axis and Y-axis, as shown in FIG. 7, to transmit the information of detection for operation of the screen of the game console.

The sensor 42 of the X-axis or Y-axis decoder 4 is connected with a circuit board 421 and secured to a bottom plate 422.

The trackball control device of the game console of the present invention is different from the prior art. The trackball can be operated smoothly and flexibly

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A trackball control device for a game console, comprising:
a base, the base comprising three bearing rollers thereon, two of the bearing rollers being perpendicular to one another and respectively provided with a decoder, the other bearing roller not having the decoder being located between the two bearing rollers having the decoder, the base comprising four pillars at four corners thereof;
a trackball, the trackball being a globe; and
a face panel, the face panel having an opening;
wherein, the trackball is disposed between the three bearing rollers, the face panel is locked to the pillars of the base, a portion of the trackball is exposed out of the opening of the face panel, the three bearing rollers are adapted to receive and position the trackball, the trackball is operated smoothly to lower resistance when the trackball is operated.

2. The trackball control device for a game console as claimed in claim 1, wherein the three bearing rollers of the base are respectively connected with a fixture, each of the three bearing rollers having a contact point to get in touch with the trackball, the contact points of the three bearing rollers being disposed at the same height.

3. The trackball control device for a game console as claimed in claim 1, wherein each of the three bearing rollers has a contact point to get in touch with the trackball, the height of the contact point being a half of the radius of the trackball.

4. The trackball control device for a game console as claimed in claim 1, wherein the two decoders of the two bearing rollers are an X-axis decoder and a Y-axis decoder, each of the decoders comprising a code disk and a sensor, the code disk and the relative bearing roller being coaxial, the code disk mating with the sensor for the code disk to be synchronously turned along with the relative bearing roller.

5. The trackball control device for a game console as claimed in claim 4, wherein the sensor of the X-axis or Y-axis decoder is connected with a circuit board and secured to a bottom plate.
